(19) United States
(12) Patent Application Publication
(10) Pub. No.: US 2004/0076230 A1
(43) Pub. Date: Apr. 22, 2004

(54) Information display unit, information display method, information display program, recording medium with the program recored therein, input device, and information processing unit

(76) Inventor: Mizuki Tomono, Tokyo (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/617,356

(22) Filed: Jul. 11, 2003

(30) Foreign Application Priority Data
Jul. 15, 2002 (JP) 2002-205484

(51) Int. Cl. H04N 7/12; H04N 11/02

(52) U.S. Cl. 375/240.01; 375/240.1

(57) ABSTRACT

The information processing unit according to the present invention is formed with a processing unit's main frame (300) for processing various types of information and an input device (100), and the input device (100) comprises a display unit (20) and a rotor (30). When the rotor is rotated, the switching request information for switching information in a plurality of layers to be processed by the processing unit's main frame (300) is set. The switching request information for switching the layers is set in response to oscillation of the rotor in the vertical direction. When switching information, image data for information currently being displayed and the image data to be displayed next are compressed to those with smaller dimensions, and then combined in the lateral direction to generate one piece of switching image data. The tone processing is carried out so that tone change occurs at least in a portion of the switching image data. When operating the rotor (30) to select the image data for the information to be displayed next, the switching image data looks like a rotating cylindrical column.

### BACKGROUND OF THE INVENTION

1. Field of the Invention

The present invention relates to an information display unit for having a plurality of image data displayed on a display section, an information display method, an information display program, a recording medium with the program recorded therein, an input device, and an information processing unit.

2. Description of Related Art

For having a plurality of image data such as pictures displayed on a display section such as a monitor, there has been known the configuration, for instances, in which the image data is displayed by selecting specific image data and executing the processing for displaying the image data, or in which a plurality of image data are reduced in the size and are displayed in a list form.

In a case where a plurality of image data are displayed one by one, or in which a plurality of image data each with the size reduced are displayed, however, the adaptability to be fully appreciated is disadvantageously low.

### SUMMARY OF THE INVENTION

It is a main object of the present invention to provide, to solve the problems as described above in the conventional technology, an information display unit with the improved adaptability to be fully appreciated, a method thereof, a program for the method, a recording medium with the program recorded therein, an input device and an information processing unit.

An information display unit according to the present invention comprises a play-list information fetching section for fetching a play-list information concerning an order for display of a plurality of image data displayed; a switching request information fetching section for fetching switching request information for requesting switching of image data displayed; and a control section for providing controls by fetching the switching request information with this switching request information fetching section so that the image data to be displayed next is displayed on the display section according to the play-list information, and the control section comprises an image compression processing section for compressing the image data being currently displayed on the display section and the image data to be displayed next according to the play-list information to the state in which the image data is displayed on the screen display with smaller dimensions in respective directions compared to those of a normal screen display of the image data and also generating one piece of compressed image data by combining a plurality of pieces of said compressed image data so that those image data adjoin to each other along the direction in which the image data is compressed; and a display control section for providing controls so that said compressed image data is displayed on said display section and then the image data to be displayed next is displayed by fetching the switching request information with said switching request information fetching section.

An information display unit according to the present invention comprises a play-list information fetching section for fetching a play-list information concerning a order for display of a plurality of image data; a switching request information fetching section for fetching a switching request information for requesting switching of image data to be displayed; and a control section for controlling the display section to display image data to be displayed next according to the play-list information by fetching switching request information with this switching request information fetching section, and the control section comprises an image compression processing section for compressing a series of image data displayed according to an order in the play-list information of the image data displayed to the state in which the image data is displayed on the screen with smaller dimensions in respective directions compared to those of a normal screen display of the image data and also generating one piece of display image data by combining a plurality of pieces of said compressed image data so that those image data adjoin to each other along the direction in which the image data is compressed; and a display control section for displaying the display image data as image data displayed.

An image display method according to the present invention comprises the steps of: fetching play-list information concerning a display order of a plurality of pieces of image data; compressing the image data being currently displayed on the display section and the image data to be displayed next according to said play-list to the state in which the image data is displayed on the screen with smaller dimensions in respective directions compared to those of a normal screen display of the image data and also generating one piece of compressed lower-layer display image data by combining a plurality of pieces of compressed lower-layer image data so that those image data adjoin to each other along the direction in which the image data is compressed; and fetching the switching request information for requesting switching of image data being currently displayed to display said compressed image data first and then display the image data to be displayed next.

An image display method according to the present invention comprising the steps of: fetching play-list information concerning a display order of a plurality of pieces of image data; compressing the image data displayed according to an order thereof in said play-list information to the state in which the image data is displayed on the screen with smaller dimensions in respective directions compared to those of a normal screen display of the image data and also generating one piece of compressed lower-layer display image data by combining a plurality of pieces of lower-layer compressed image data so that those image data adjoin to each other along the direction in which the image data is compressed; and fetching the switching request information for requesting switching of image data to display the image data of said display image data.

An information display program according to the present invention makes a computing section execute the information display method according to the present invention as described above.

A recording medium, according to the present invention, with the information display program recorded therein readable via arithmetic unit.

An input device according to the present invention comprises the information display unit according to the present invention as described above, and an operating section for inputting data for the switching request information indicating that image data displayed by said information display unit in response to the input operation on the display section.

An information processing unit according to the present invention comprises the information display unit according to the present invention described above, and an information processing section for processing information correlated to the image data displayed by the information display unit on the display section.

An information processing unit according to the present invention comprises the input device according to the present invention described above, and an information processing section for processing information correlated to the image data displayed by the information display unit on the display section of this input device.

### BRIEF DESCRIPTION OF THE DRAWINGS

FIG. 1 is a flat view showing an input device in one embodiment of the present invention;

FIG. 2 is a side view showing the input device in the embodiment above;

FIG. 3 is an end face view showing the input device in the embodiment above;

FIG. 4 is a block diagram showing configuration of an information processing unit in the embodiment above;

FIG. 5 is an explanatory view showing layered structure of information to be processed by the information processing unit in the embodiment above;

FIG. 6 is an explanatory view showing operations for generating switching image data or display image data in the embodiment above;

FIG. 7A to FIG. 7C are explanatory views each showing a display situation in switching a source in the embodiment above;

FIG. 8A to FIG. 8E are explanatory views each showing a display situation in switching lower-layer information in a source of “@ab” in the embodiment above;

FIG. 9 is a flow chart showing operations for processing information by the information processing unit in the embodiment above; and

FIG. 10A to FIG. 10C are views each showing a screen display in regenerating musical data in a source of “HDD” in the embodiment above.

### DETAILED DESCRIPTION OF PREFERRED EMBODIMENT(S)

One embodiment of the present invention is described below with reference to the drawing.

[Configuration of the Input Device]

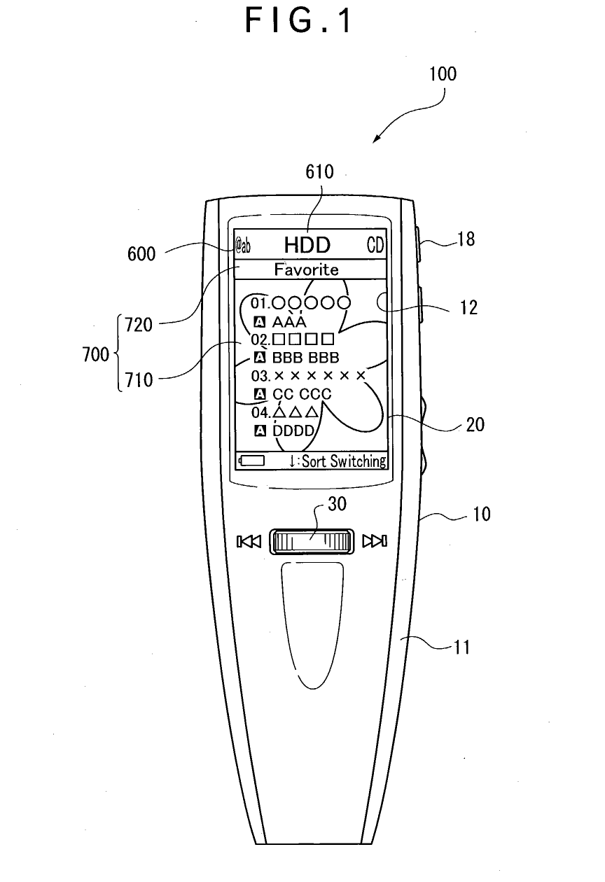

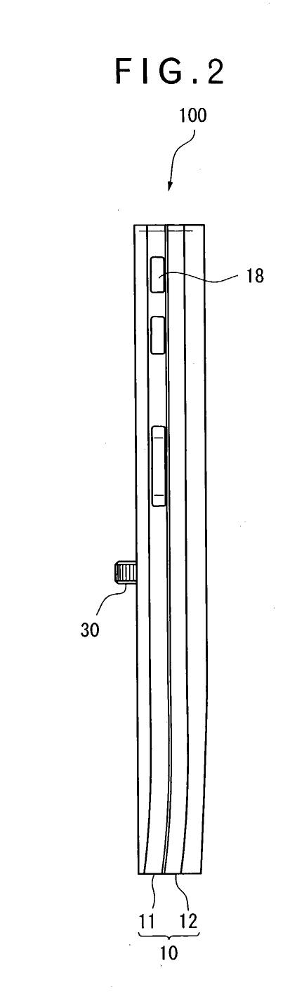

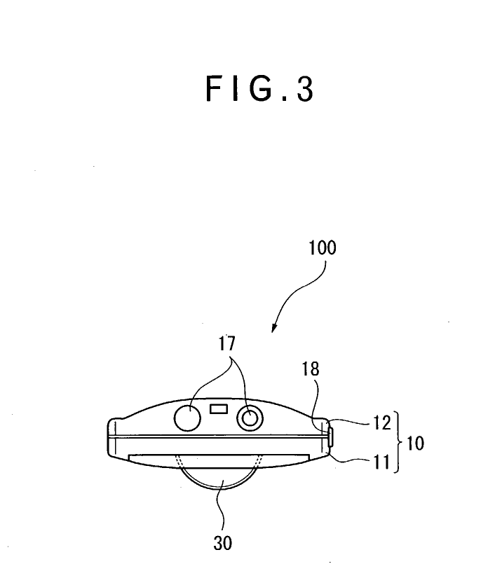

At first, configuration of an input device in the embodiment is described below with reference to FIG. 1 to FIG. 3. FIG. 1 is a flat view showing an input device. FIG. 2 is a side view showing the input device. FIG. 3 is an edge face view showing the input device. It is to be noted that FIG. 1 shows, for convenience in description, the state in which image data is displayed.

In FIG. 1 to FIG. 3, an input device 100 is a so-called remote controller for controlling operation of a main frame of a processor in the information processing unit described hereinafter. The input device 100 has a rectangular main frame casing 10 longitudinal in the vertical direction. Linked to the casing 10 for the main frame are a top casing 11 and a rear casing 12. In the main frame casing 10, a lower edge section, which is one of the edge sections, is slightly tapered toward the tip section so that a user can easily grip it. Further the main frame casing 10 has a form in which the thickness of the substantially central portion in the vertical direction, which is the longitudinal direction, larger than those in other portions and surfaces of the top casing 11 and the rear casing 12 are curved.

In each of the top casing 10 and rear casing 11, a window section 15 shielded with a light-transmissible member (not shown) is provided at an upper edge section thereof, which is another edge section. Provided in the main frame casing 10 is a display unit 20 as a display section in the state in which a display screen having a longer dimension in the vertical direction faces to the window section 15. An organic EL panel or a liquid crystal panel is used, for instance, for this display unit 20. An organic EL panel enabling high speed processing is especially preferable for displaying image data.

Further a rotor 30 is provided at a substantially central portion of each of the top casing 11 of the main frame casing 10. This rotor 30 has a substantially disc-like form with irregularities for prevention of slipping provided in the peripheral surface, and a portion of the external periphery is exposed on the main frame casing 10. The rotor 30 is provided so that it can be rotated around a rotation shaft (not shown) and extending in the vertical direction equivalent to the longitudinal direction of the main frame casing 10. Further the exposed portion of the external peripheral surface of the rotor 30 is provided so that it can oscillate.

Provided on the upper edge face of the main frame casing 10 is a communication window section 17 for sending and receiving information via a wireless medium. Further such components as a power switch 18 are provided on one side face of the main frame casing 10.

[Configuration of the Information Processing Unit]

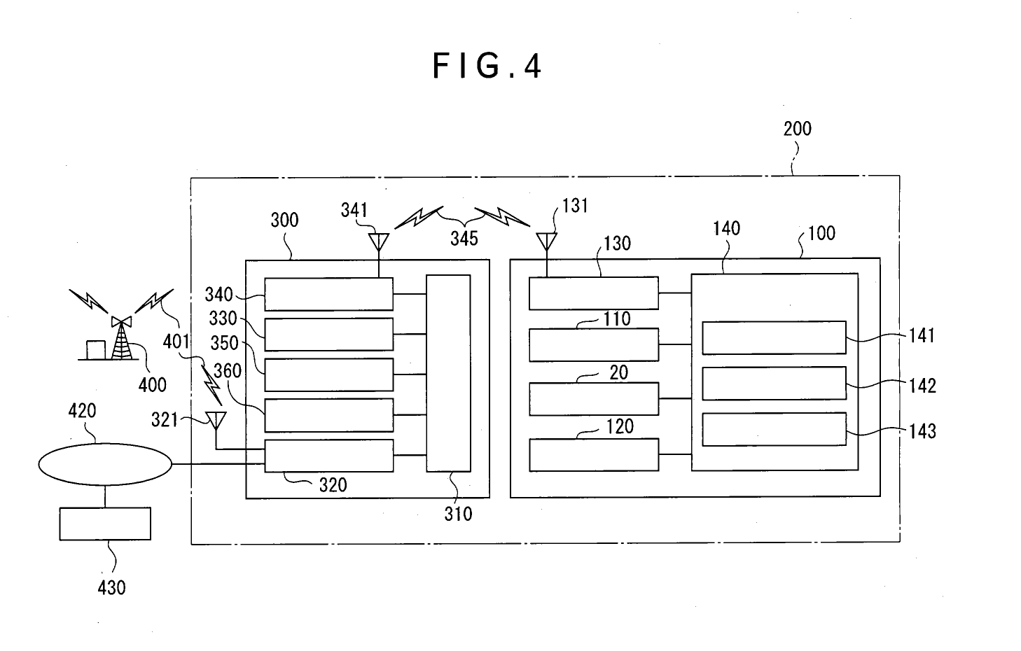

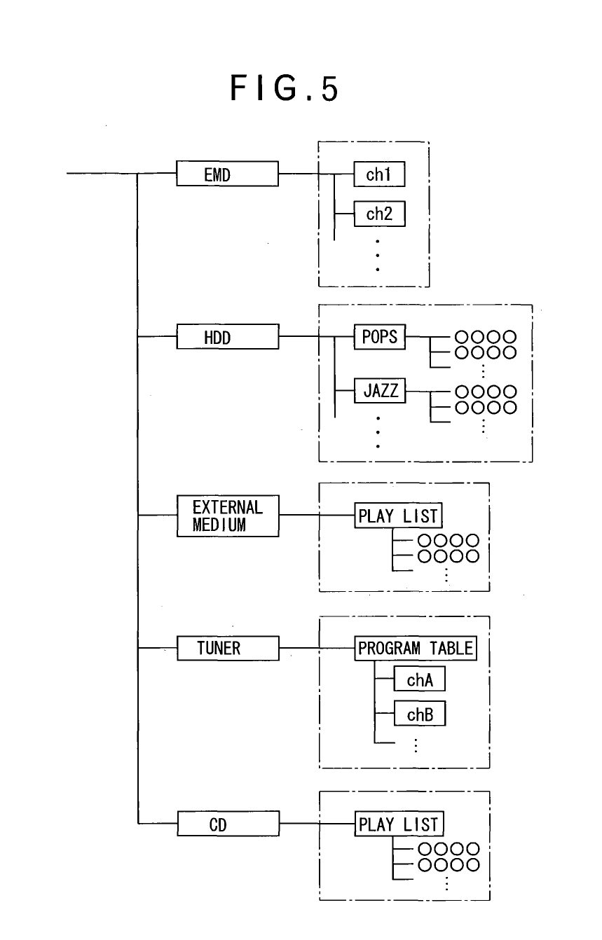

Internal configuration of the information processing unit in the embodiment is described below with reference to FIG. 4 and FIG. 5. FIG. 4 is a block diagram showing configuration of the information processing unit. FIG. 5 is an explanatory view showing layered structure of the information processed by the information processing unit.

In FIG. 4, designated at the reference numeral 200 is an information processing unit, and this information processing unit 200 executes the processing for output of information as image data or musical data as information, for instance, as a display or as sounds. This information processing unit 200 comprises an input device 100 and a main frame 300 of the processing body.

The processing unit's main frame 300 processes information based on a signal transmitted from the input device 100. The processing unit's main frame 300 comprises a main frame control section 310 configured as a program developed on an OS (Operating System) for controlling operations of the entire system, an information fetching section 320, an output section 330, a communicating section 340, a driver 350, and a storage section 360 for the main frame.

Connected to the main frame control section 310 are the information fetching section 320, output section 330, communicating section 340, driver 350, and the main frame's storage section 360 for controlling various operations and also for processing the information according to the necessity.

The information fetching section 320 has a receiving antenna 321. The information fetching section 320 also functions as a so-called tuner, and is controlled by the main frame control section 310, and fetches information transmitted from, for instance, an earth station 400 or an artificial satellite (not shown) via a wireless medium 401 with the receiving antenna 321. The wireless medium includes, for instance, electric waves, electromagnetic waves, and light. The configuration is allowable in which information is fetched through a cable.

The information fetching section 320 is connected, for instance, to a server device 430 via a network 420. Further the information fetching section 320 fetches various types of information from the server device 430. The network 420 can be, for instance, the Internet based on a general-purpose protocol such as the TCP/IP (Transmission Control Protocol/Internet Protocol), an intranet, a LAN (Local Rea Network), etc.

Information fetched by the information fetching section 320 includes, but not limited to, image data, musical data, program information, personal information, and information on business transaction. The information fetching section 320 outputs the fetched information to the main frame control section 310.

The output section 330 outputs information under control by the main frame control section 310. More specifically, the output section 330 outputs information as sounds from a sound-generating section such as a speaker (not shown), or outputs information as a screen display with a display section of the main frame such as a monitor (not shown).

The communicating section 340 has a communication antenna 341. The communicating section 340 is connected to the input device 100 so that signals can be transmitted therefrom or received thereby via a wireless medium 345 with the communication antenna 341. For signal transaction, in addition to the wireless medium 345 such as light like infrared rays, electric waves, sonic waves, and electromagnetic waves, a cable such as an electric cable or a telephone cable may be used. The communicating section 340 outputs, under control of the main frame control section 310, a signal received from the input device 100 to the main frame control section 310, and also transmits a signal from the main frame control section 310 to the input device 100.

The driver 350 fetches information from external media (not shown) under control of the main frame control section 310. The external medium can be a recording medium dismountably set in the processing unit's main frame 300, for instance, an optical disc, a magnetic disc, or an opt-magnetic disc such as a CD (Compact Disc), a DVD (Digital Versatile Disc) or an MD (Mini Disc) or a memory card (MC).

The main frame's storage section 360 is, for instance, a hard disc in which information can be recorded.

The processing unit's main frame 300 processes information concerning, for instance, radio programs or television programs fetched by the information fetching section 320, musical data or image data distributed via the server device 430, image data or musical data processed by the driver 350 and recorded in an external medium, or musical data or image data recorded in the main frame's storage section 360 according to the necessity, and outputs the processed data from the output section 330.

The information is processed as a source for a tuner, for instance, when a radio program is outputted, a source for television when a television program is outputted, as a source, for instance, “EMD” (Electric Music Distribution) (to be displayed as “@ab” for convenience in description of the embodiment indicating a name of a distribution-service company) when information such as musical data distributed from the server device 430 is outputted, as a source for a “CD” when information for a CD-DA (Compact Disc-Digital Audio) as an external medium is outputted, as a source for an “MC” when information for a memory card as an external medium is outputted, and as a source for a “HDD” (Hard Disc Drive) when information for the main frame's storage section is outputted. Namely, the processing unit's main frame 300 processes information for sources such as, for instance, TUNER, TV, EMD, CD, MD, DVD, MC, and HDD. Stored in the sources are a plurality of pieces of lower-layer information such as those for radio programs, television programs, or musical data recorded in an external medium or the main frame's storage section 360.

On the other hand, the input device 100 comprises an operating section 110, a display unit 20, a storage section 120, an information communicating section 130 installed as a program developed on an OS (Operating System) for controlling operations of the entire system, and a control section 140.

The operating section 110 comprises a rotor 30, a rotation detecting sensor (not shown) for detecting rotation of the rotor 30, and an oscillation detecting switch (not shown) for detecting oscillation of the rotor 30. The operating section 110 outputs rotation of the rotor detected by the rotation detecting sensor or oscillation of the rotor 30 detected by the oscillation detecting switch as an electric signal to the control section 140.

For instance, the control section 140 recognizes a request, from the operating section 110 in association with rotation of the rotor 30, for an order of the transmission of sources or information in the data structure processed by the processing unit's main frame 300, or, when the lower-layer information is musical data or image data, a request for changing the regeneration speed or changing input information such as figures or letters. Alternatively, the control section 140 recognizes the request as a request for switching the information layer or an instruction for execution of determination or distribution of input information such as figures or letters generated in association with oscillation of the rotor 30 in the vertical direction.

For instance, in the case of a request for transmission of an order of sources, “TUNER”, “TV”, “EMD”, “HDD”, “CD”, “MD”, “DVD”, “MC” are successively displayed on the display unit 20 in the loop-like state with “TUNER” again displayed after “HDD” according to the order based in the order information which is play-list information stored in the storage section 120. Further in the case of the transmission of an order of the lower information, the information is displayed in a loop with the first lower-layer information again displayed after the lower-layer information at the last order according to the play-list information or program information stored in the storage section 120. What is described is true, for instance, for a case of displaying channel numbers for TV programs in the ascending order based on a program table or for a case of regenerating musical data recorded in an external medium.

The storage section 120 is, for instance, a memory, and stored various types of information therein. The information stored in the storage section 120 includes, for instance, a source at the highest layer in the layered structure shown in FIG. 5, the lower-layer information at the lower-layer of each source, and further includes various types of image data corresponding to the sources or the lower-layer information. Although description of this embodiment above assumes a case where the lower-layer of the source at the highest layer is two-layered, the present invention is not limited to this configuration, and also multiple-layered data structure is allowable in this invention. The storage section 120 outputs information stored therein to the control section 140 under control by the control section 140, and also stored therein information sent from the control section 140.

The display unit 20 displays various image data on the screen under control by the control section 140. The display unit 20 also displays image data corresponding to sources or lower-layer information in response to switching of a source or lower-layer information to be processed in response to an input operation in the operating section 110.

The display data corresponding to a source to be displayed is displayed with a dimension in the horizontal direction longer than that in the vertical direction at a top edge side on the display screen, namely with a form having the longitudinal direction along the lateral direction of the input device which is equivalent to the lateral direction of the display screen. In other words, as shown, for instance, in FIG. 1, source image data 610 corresponding to any of the sources “TUNER”, “TV”, “EMD”, “CD”, “MD”, “DVD”, “MC”, and “HDD” is generated and displayed as the display image data 600. The sources as described above are successively display in the order from the higher layer to the lower-layer at a lower edge section of the display screen. When the source image data is displayed, the selected layer is displayed, for instance, with the background colored with a bright color, and the layers not selected are displayed each with the background in the dark grey color.

Main image data 700, which is image data corresponding to the lower-layer to be displayed, is displayed in succession to and under the display image data 600 for sources displayed according to the layer order from the top edge of the display screen. The main image data 700 comprises, as shown, for instance, in FIG. 1, contents image data 710 as image relating to the contents of the lower-layer information and a name bar 720 provided over the contents image data 710 and showing a channel number or a title of the lower-layer information. This name bar 720 is also displayed with a band-like form longer in the horizontal direction like the display image data 600. The contents image data 710 comprises, for instance, image data provided through each channel or background image data previously stored in the storage section 120 and contents of the play-list information or the lower-layer information superimposed on the former data.

When the lower-layer information is selected, the name bar 720 is displayed, for instance, with the background colored with a bright color like the display of a source. When the upper layer information is selected but the lower-layer information is not selected, for instance, the main image data 700 is not displayed, or the name bar 720 is displayed without the background colored with any color.

The information communicating section 130 has an information communicating antenna 131. This information communicating section 130 is connected to the communicating section 340 of the processing unit's main frame 300 via the information communicating antenna 131 so that signals can be transmitted therefrom or received thereby via the wireless medium 345. The information communicating section 130 transacts information with the communicating section 340 of the processing unit's main frame 300 under control by the control section 140.

The control section 140 controls all operations of the input device 100. Further the control section 140 comprises a image compression processing section 141, a tone processing section 142, and a display control section 143.

The image compression processing section 141 executes the processing for compression of image data to be displayed on the display unit 20 as described in details below, and also combine the compressed image data according to the necessity to generate the display image data 600 or switching image data 650 which is compressed image data. The display image data 600 relates to a source to be subjected to data processing in the processing unit's main frame 300 or an image to be displayed on the display unit 20 in response to the lower-layer information. The switching image data 650 relates to images displayed once for a short period of time, on the display unit 20 when the display image data 600 is switched to another one.

The tone processing section 142 executes the tone processing for changing a color tone of displayed image data such as the switching image data 650 or display image data 600 generated by the image compression processing section 141 or main image data 700 at least in a portion thereof.

The display control section 143 executes the processing for making the display unit 20 display thereon image data such as the switching image data 650 or display image data 600 generated by the image compression processing section 141 or the main image data 700. Further the display control section 143 executes the processing to display the switching image data for a prespecified period of time and then display image data such as the display image data 600 to be displayed next or main image data 700 based on the switching request information for requesting switching of image data such as the display image data 600 to be displayed in response to an input operation in the operating section 110 or the main image data 700.

Basic components of the information display unit according to the present invention is the information communicating section 130 which functions as a play-list information fetching section for fetching play-list information, the operating section 110 which functions as a switching request information fetching section for fetching switching request information requesting switching of image data; and the control section1 140 comprising the image compression processing section 141 and the display control section 143.

(Operations for Processing Image Data)

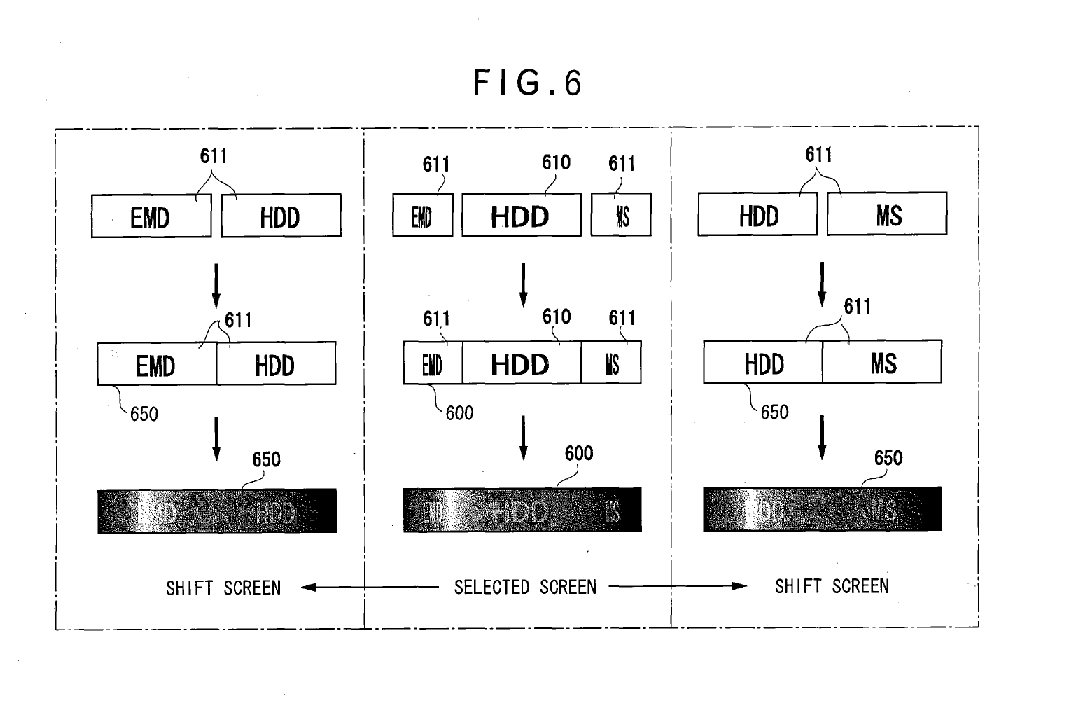

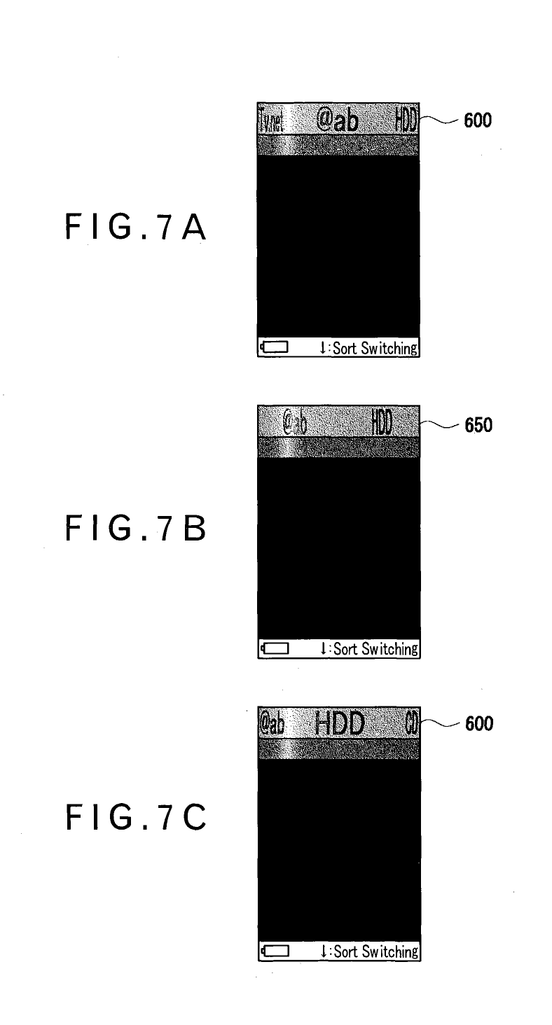

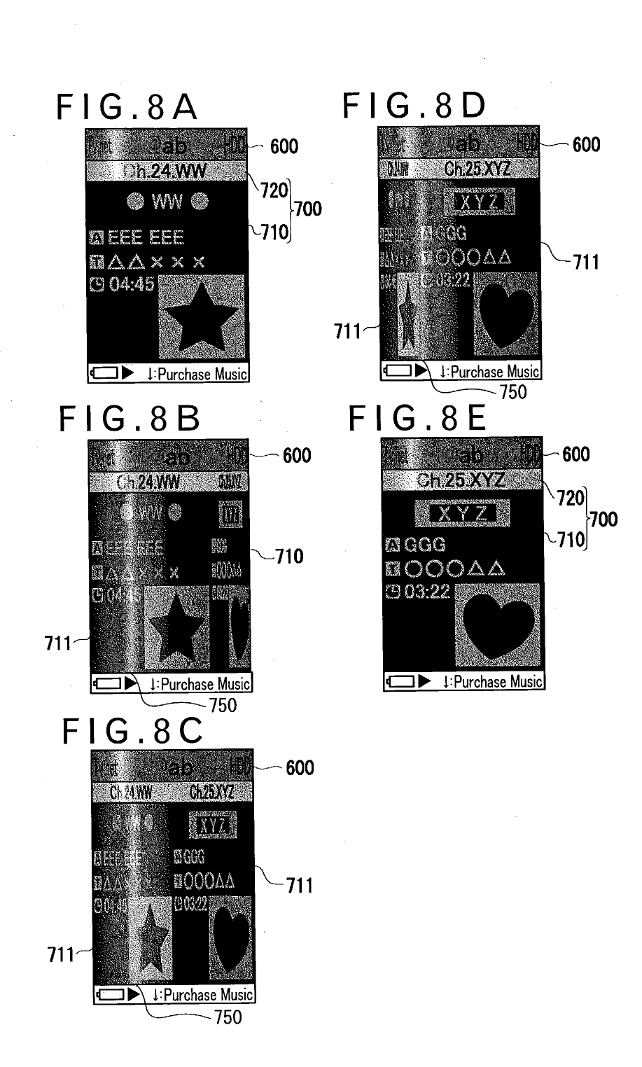

The operations performed by the control section for processing image data is described with reference to FIG. 6 through FIG. 8. FIG. 6 is an explanatory view illustrating operations for generating the switching image data or display image data. FIG. 7A to FIG. 7C are explanatory views each showing the display situation in switching a source. Of these figures, FIG. 7A shows a display screen in the state where “@ab” is set as “EMD”, FIG. 7B shows a display screen for a first frame of switching image data transitionally displayed when the source is switched from “@ab” to “HDD”, and FIG. 7C is a display screen in the state where “HDD” has been set. FIG. 8A to FIG. 8E are explanatory views each showing the display situation in switching the lower-layer information in the source of “@ab”. Of these figures, FIG. 8A is a display screen in the state where “ch.24.ww” has been set, FIG. 8B shows a display screen for a first frame of switching data displayed when “ch.24.WW” is switched to “ch.25.XYZ”, FIG. 8C is a display screen for a second frame of the switching image data transitionally displayed when “ch.24.WW” is switched to “ch.25. XYZ”, FIG. 8D is a display screen for a third frame of the switching image data transitionally displayed when “ch.24.WW” is switched to “ch.25.XYZ”, and FIG. 8E is a display screen in the state where “ch.25. XYZ” has been set. It is to be noted that FIG. 7A to FIG. 7C each show, for convenience in description, the state where main image data corresponding to the lower-layer information is not displayed.

The image data processing carried out by the image compression processing section 141 includes the image generation processing for generating the display image data 600 for the image data corresponding to a source and the switching image data 650, and the image generation processing for generating the switching image data for the image data corresponding to the lower-layer information.

The processing for generating the display image data 600 for a source includes the processing for compressing the source image data 610 set for each source and stored in the source section 120 and the processing for generating the compressed source image data 611 with the source image data 610 according to the necessity to generate one piece of display image data 600 as shown in FIG. 6 and in FIG. 7A to FIG. 7C.

The processing for compression of the display image data 600 for a source is performed for compressing the source image data 610 to those in the state suited to being displayed on a screen with the smaller dimensions, in other words, for compressing the source image data 610 at a prespecified compression ratio to those in the state, for instance, where the dimension in the longitudinal direction equivalent to the lateral direction of the display screen of the display unit 20 is shortened. It is to be noted that a compression ratio in the embodiment shown in FIG. 6, at which the source image data 610 is compressed, is, for instance, 12.5% (1/6) or 1/3.

For generating the display image data 600 for a source, as shown in FIG. 6, FIG. 7A and FIG. 7C, the compressed source display image data 611 are located in both sides of the source image data 610 for the source set in response to an input operation in the operating section 110 to be processed to generate one piece of display image data 600. The compressed source image data 611 combined with the source image data 610 corresponds to preceding and following sources as defined by the order information indicating the loop-like processing order in the source to be processed. The combination is performed in the state in which the combined pieces of image data adjoin each other in the lateral direction of the display screen equivalent to the direction in which the compression was made, namely in the state in which the pieces of image data adjoin each other and are arrayed in the lateral direction of the display screen. One piece of display image data 600 is generated as described above.

The processing for compressing the switching image data 650 for a source, for instance, as shown in FIG. 6, is performed so that the source image data 610 is displayed with smaller dimensions on the screen, namely the compression is performed at a prespecified compression ratio so that the dimension in the longitudinal direction, which is equivalent to the lateral direction of the display screen of the display unit 20, is reduced. The ratio at which the source image data 610 is compressed in this embodiment shown in FIG. 6 and in FIG. 7B is, for instance, 62.5% (5/8) or 75% (3/4).

In the processing for generating the switching image data 650 for a source, the switching image data 650 is generated by combining the compressed source image data 611 as shown, for instance, in FIG. 6 and FIG. 7. The compressed source image data combined as described above corresponds to sources before and behind thereof in the loop-like processing order in the source to be processed. The combination is performed so that a pair of compressed source image data 611 are positioned side by side in the lateral direction of the display screen equivalent to that in which compression was made. One piece of switching image data 650 is generated as described above.

To generate the switching image data for the lower-layer information positioned in the lower-layer of a source, the processing for compression of the main image data 700 set for each lower-layer information and the processing for combining the compressed main image data 711 according to the necessity to generate one piece of switching image data 750 are performed as shown in FIG. 8A to FIG. 8E. The main image data 700 set for each lower-layer information is, for instance, those stored in the storage section 120 or those fetched by the information communicating section 130 from the processing unit's main frame 300.

The processing for compression of the switching image data 750 for the lower-layer information is carried out, as shown, for instance, in FIG. 8B, FIG. 8C, and FIG. 8D so that the image data 700 is displayed on the screen with the smaller dimension in the lateral direction, and in other words the compression processing is performed at a prespecified ratio so that the main image data 700 is displayed on the screen with the dimension reduced in the longitudinal direction equivalent to the lateral direction of the display screen of the display unit 20. It is to be noted that the compression ratio in the embodiment shown in FIG. 8 is 25% (1/4), 50% (1/2) and 75% (3/4).

In the processing for generating the switching image data 750 for lower-layer information, as shown, for instance, in FIG. 8B, FIG. 8C, and FIG. 8D, the compressed main image data 711 is combined to generate the switching image data 750. The compressed main image data 711 combined as described above corresponds to those before and behind thereof in the order information such as play-list information or program information described above in the lower-layer information to be processed. The combination is performed to combine a pair of compressed main image data 711 so that the two pieces of image data are positioned side by side in the lateral direction of the display screen equivalent to that in which the compression was made. One piece of switching image data 750 is generated as described above.

In this embodiment, for the lower-layer information, the main image data 700 itself corresponds to the display image data 600 for a source. Namely, for the lower-layer information, image data corresponding to the display image data 600 comprising the main image data 700 and the compressed main image data 711 positioned in both sides thereof is not generated. The image data corresponding to the display image data 600 is not generated because the main image data 700 corresponding to the lower-layer information at the lowest layer contains a lot of information to be displayed.

Further the processing for changing a tone is carried out by the tome processing section 142 in the control section 140 to the display image data 600 and the switching image data 650 in the generated source and to the switching image data 750 for the lower-layer information so that the tone change at least in the lateral direction will be generated in a band form in the vertical direction equivalent to the longitudinal direction of the input device 100 as shown in FIG. 6 through FIG. 8A to FIG. 8E. The tone processing section 142 executes the tone processing, as shown in FIG. 8A and FIG. 8E, to the name bar 720 of the main image data 700 for the lower-layer information at positions substantially similar to those in the display image data 600 or switching image data 650 in the source, while the tone processing is not performed to the contents image data 730.

[Operations of Information Processing Unit]

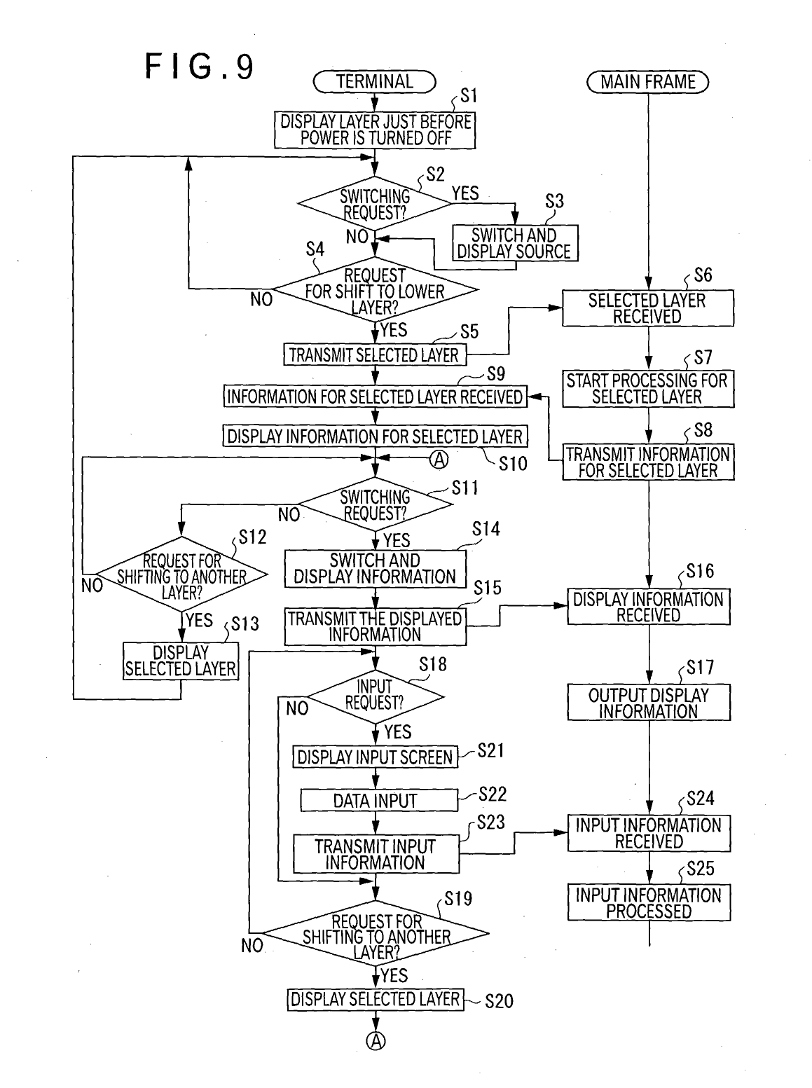

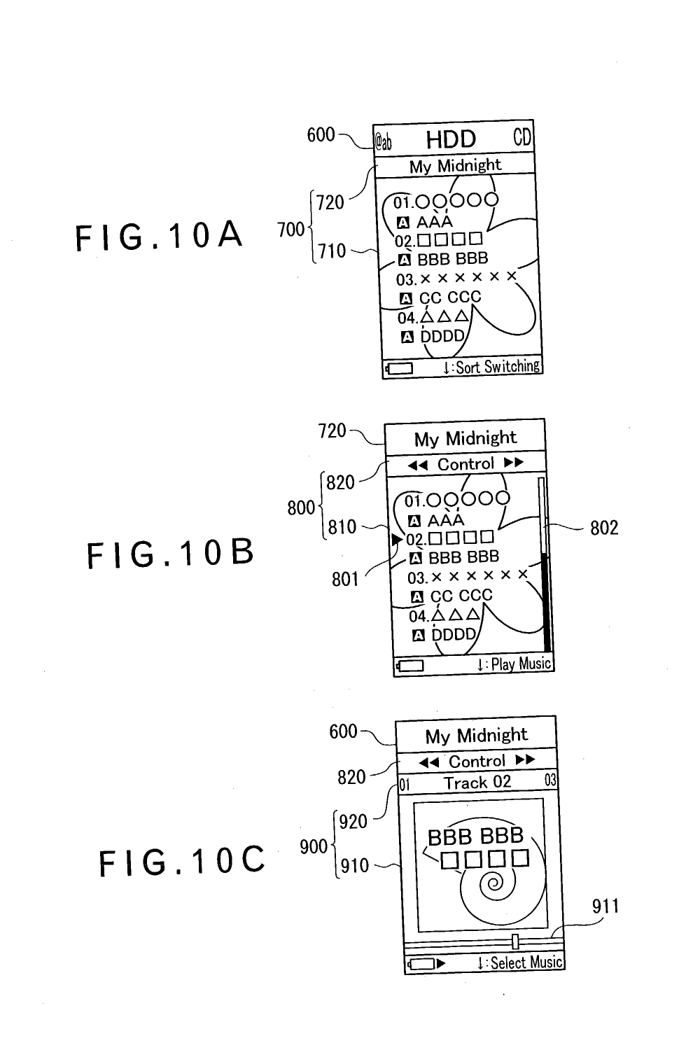

Next operations performed by the information processing unit for processing information is described with reference to FIG. 9 and FIG. 10A to FIG. 10C. FIG. 9 is a flow chart showing operations performed by the information processing unit for processing information. FIG. 10A to FIG. 10C are views each showing a screen display when musical data in the source of “HDD” is regenerated. Of the figures, FIG. 10A is a view showing a screen display when a directory for the lower-layer of the source is selected, FIG. 10B is a view showing a screen display when musical data within a directory is selected, and FIG. 10C is a view showing a screen display when the musical data is being regenerated. In the screen displays shown in FIG. 110A to FIG. 10C, the display for tone processing is omitted for convenience in description.

At first, a power switch 18 of the input device 100 is operated to start the input device 100. When the input device 100 is started, the control section 140 controls the information communicating section 130 to output a signal indicating that the processing unit's main frame 300 is started. When the communication section 340 of the processing unit's main frame 300 receives the signal, the control section 310 executes the processing for starting operations of the processing unit's main frame 300 for enabling information processing.

When the input device 100 is started, the control section 140 executes the processing for restoring the previous state stored in the storage section 120 (step S1). Namely, the control section 140 reads out the source or lower-layer information having been selected just before the power switch was turned OFF last, and provides controls so that the display image data 600 as the image data for the source or the lower-layer information or the main image data 700 is displayed on the display unit 20. Further the control section 140 controls the information communicating section 130 to output indicating that the source or lower layer information is selected. When the communicating section 340 of the processing unit's main frame 310 receives the signal, the main frame control section 310 controls the information fetching section 320, output section 330, communicating section 340, driver 350, and the main frame storage section 360 according to the necessity so that the selected information is outputted from the output section 330.

In this state, as the information to be processed is lower-layer information at the lowest layer, the display screen as shown in FIG. 1 or FIG. 8A, and FIG. 8E is provided on the display unit 20. Namely, a message indicating that a name bar for the main image data corresponding to the information has been selected is displayed as a screen display, for instance, with the background colored with a bright color, and also the top layer of the lower-layer information is displayed, for instance, with the dark grey color indicating that the top layer has not been selected.

The case where the processing previously performed by the processing unit' main frame 300 was for regenerating the musical data stored in the “HDD” as the information stored in the main frame storage section 360 is described with reference to FIG. 10A to FIG. 10C.

When the information stored in the “HDD” as a source for the last processing is read out, the main image data 700 for a play-list, which is play-list information as one of directories in the lower layer of the “HDD” source, is displayed as shown in FIG. 10A. A plurality of main image data 700 for this play-list are stored, for instance, in the storage section 120, or in the main frame storage section 360. For instance, when a plurality of information categorized to any criteria such as a play-list of musical data categorized according to artists and albums are stored in the “HDD”, the contents image data 710 of the play-list belonging to the category to which the musical data last processed is categorized is displayed.

As the display of the main image data 700 shown in FIG. 10A shows the state in which a category belonging to the lower layer of the “HDD” source has been selected, the display control for the selected layer is provided. Namely, under control by the display control section 143, for instance, the name bar 720 for the main image data 700 is displayed with the background colored with a bright color indicating that the layer has been selected, and the display image data 600 for “HDD” at the top layer is displayed with the dark grey color indicating that the layer has not been selected.

Then the control section 140 enters, in response to an input operation of the rotor 30, the queuing state for entry of a layer switching request to select another source or musical data which is lower layer information in a further lower layer in a directory, or for a request for switching to another category in the selected directory (step S2). In this step S2, when the user rotates the rotor 30 to indicate the user's hope to select a category other than the current one, the input device 100 executes the processing corresponding to this input operation.

Namely the control unit 140 fetches an electric signal outputted from a rotation sensor of the operating section 30 in response to a rotating operation of the rotor 30, and recognizes the signal as switching request information indicating the necessity of switching a category to be processed in a layer of this category. Then the control section 140 switches the category from the main image data 700 shown in the display unit 200 to the main image data 700 corresponding to the category selected anew in response to the rotating direction of the rotor 30.

When switching display of the main image data 700, whether an order of the newly selected category precedes or follows the current category is determined based on the order information for the directory which is play-list information in the “HDD” source and the fetched electric signal. Then the display is switched to the main image data 700 corresponding to the next category (step S3).

In this processing for switching a display, the control section 140 subjects the main image data 700 having been displayed and the main image data 700 corresponding to the next category to the compression processing and the generating processing by the image compression processing section 141 as described above with reference to FIG. 8A to FIG. 8E to generate, for instance, three pieces of switching image data 750 each compressed at a different compression ratio. Further the switching image data 750 is subjected to the tone processing by the tone processing section 142. Then the display control section 143 executes the processing so that the three pieces of switching image data 750 having been subjected to the tone processing are successively displayed in the ascending order of the compression ratios for the main image data 700 for the lower layer information and then executes the main image data 700 for the next lower layer information.

The description above assumes a case in which the image generation processing and tone processing are carried out in response to the switching request information and the generated switching image data 750 and the next main image data 700 following the former image data are displayed, but the configuration is allowable in which the switching image data 750 is previously prepared and stored in the storage section 120 or in the main frame's storage section 360. Further the configuration is allowable in which, when the switching request information is recognized, based on an electric signal from the operating section 110 and the play-list information, the corresponding switching image data 750 is read out from the storage section 120 and is successively displayed and then the main image data 700 for the next lower layer information is displayed.

A period of time for displaying the three pieces of switching image data 750 is previously specified to that in which each of the switching image data 750 can hardly be visually identified, for instance, from 0.5 section to about 1 second in all. With this processing, the user feels that the display screen of the main image data 700 for the lower-layer information displayed on the display section 20 is like a cylindrical column rotating around the vertical axis of the input device 100 as the rotation axis.

The configuration is allowable in which, when switching a display of the main image data 700, information transaction is carried out for fetching the play-list information for the main image data 700 to be displayed from the processing unit's main frame 300 is carried out, or the play-list information previously stored in the storage section 120 is used for display. With the configuration allowing fetching play-list information from the processing unit main frame 300 according to the necessity, a play-list reflecting the last information updated from time to time can be displayed and information processing can be performed based on optional conditions set for data entry.

On the other hand, when an input operation for oscillating the rotor 30 downward is performed by a user to regenerate any musical data as lower-layer information for any category (step S4), the control section 140 executes the processing for selection of the lower-layer information. In this step, the control section 140 executes the musical data processing for making the processing unit's main frame 300 select and regenerate musical data in response to an operation of the rotor 30 based on the screen display of the processing image data 800 and the processing screen switching processing for deleting the display image data 600 indicating a layer of a source and displaying the processing image data 800 in place of the contents image data 710 as shown in FIG. 10B.

In the musical data processing, as described above, a category selected for fetching play-list information belonging to the category is transmitted to the processing unit's main frame 300 (step S5). The processing unit's main frame 300 having received the signal for the category (in step S6) starts the “HDD” as a source to which the category belong to fetch the play-list information for the category (step S7) and fetches the play-list information. Then the fetched play-list information is transmitted to the input device 100 (step S8), so that the input device 100 receives the play-list information (step S9).

In the screen switching processing, the processing image data 800 shown in FIG. 10B is displayed (step S10). The processing image data 800 shown in FIG. 10B comprises the contents image data 810 showing a cursor 801 for selecting a play-list and a scroll bar 802 for showing a position of the play-list provided as a screen display and an explanation bar 820 similar to the name bar and illustrating the contents for musical data selected by moving the cursor 801.

The screen display shown in FIG. 10B is the processing image data 800 used for selecting musical data as lower-layer information at a lower level from the category layers in the “HDD” source. Therefore, in the processing image data 800, the name bar 720 for a category corresponding to an upper layer is displayed with the dark grey background indicating that the category has not been selected, and the explanatory bar 820 is displayed with a bright color indicating that the explanatory bar 820 has been selected.

After the processing image data 800 shown in FIG. 10 is displayed, the control section 140 enters the queuing state for entry of switching request information such as switching request information for selecting musical data which is lower-layer information at a lower-layer of this category or for shifting to an upper layer to switch the category or the source to another one (step S11). When the control section 140 recognizes the switching request information for switching a layer (step S12), the control section 140 has the image data belonging to the layer displayed (step S13), and returns to step S2.

More specifically, when the rotor 30 of the input device 100 is oscillated upward by a user, an oscillation detection sensor (not shown) of the operating section 110 outputs an electric signal corresponding to oscillation of the rotor 30. The control section 140 fetches this electric signal to recognize the oscillating direction of the rotor 30 based on the electric signal as switching request information for switching from the layer to the top layer, and executes the switching processing. Namely, for instance, the state shown in FIG. 10B is switched to that shown in FIG. 10A.

After the processing image data 800 shown in FIG. 10B is displayed, when the rotor 30 is rotated by a user, the control section 140 executes the processing for moving the cursor 801. When the rotor 30 is oscillated downward, the control section 140 executes the processing for regeneration of the musical data at the cursor position.

In the processing for regeneration of the musical data, the control section 140 provides controls for switching the display to the contents image data 900 to be regenerated shown in FIG. 10C (step S14). Further, the control section 140 outputs a signal for regeneration of the selected musical data (step S15) to the processing unit's main frame 300 so that it receives the signal (step S16), and the musical data belonging to a prespecified category in the “HDD” source is regenerated in the processing unit's main frame 300 (step S17).

The contents image data 900 to be regenerated comprises the image data 910 such as image data correlated to the musical data to be regenerated in place of the contents image data 810 of the processing image data 800 or the image data with musical data such as a name or an artist relating to the musical data to be regenerated superimposed on the background image stored in the storage section 120 or in the main frame storage section 360, and a rack bar 920 for displaying a track being regenerated in the display state similar to that of the display image data 600. A cursor bar 911 indicating a position at which the musical data is regenerated is provided in the image data 910.

The contents image data 900 shown in FIG. 10C is displayed with the background colored with a bright color indicating that the track 920 currently being regenerated has been selected. In the screen display shown in FIG. 10C, the explanation bar 820 corresponds to a range in which the regeneration speed of the musical data to be regenerated can be changed in response to rotation of the rotor 30, and also the explanation bar 820 is displayed with the background colored with a bright color.

Then the control section 140 determines whether a request for entry is present or not (step S18). When the musical data in “HDD” is being processed, a request for entry of conditions to be set is not issued, so that the control section 140 enters the queuing state for entry of a the switching request information for switching the musical data currently being regenerated to other data or for the switching request information for shifting to an information layer for switching a category or a source at a higher layer (step S19). If there is no request for switching, the control section 140 returns to step S18 for continuing the processing for regeneration of the musical data.

In step S19, when the control section 140 recognizes switching request information, namely when the control section1 140 recognizes an electric signal corresponding to oscillation of the rotor 30 generated in response to upward oscillation of the rotor 30 with the oscillation detection sensor, the switching processing is executed. In the example in which the musical data in this “HDD” is being regenerated, when the state is as shown in FIG. 10C, the screen display is switched to that shown in FIG. 10B with a signal for termination of the regeneration processing transmitted to the processing unit's main frame 300, thus the regeneration processing being terminated. Then the layer is shifted to a higher layer with the control section 140 returning step S11, namely to the queuing state for entry of conditions to be set for the layer.

When a user performs an input operation for processing the information in a source at other layer higher than the layer corresponding to the information which the user is currently processing, the input device 100 executes the processing corresponding to this input operation. Namely when the rotor 3 of the input device 100 is oscillated upward by the user, an oscillation detecting sensor now shown of the operating section 110 outputs an electric signal corresponding to oscillation of the rotor 30. The control section 140 fetches this electric signal, recognizes the oscillating direction of the rotor 30 based on the electric signal as switching request information for switching from the current layer to a higher layer, and executes the switching operation.

Namely the control section 140 executes the control processing for stopping the lower-layer information currently being processed by the processing unit's main frame 300 and switching the operating mode to that in which the lower-layer information can be switched to that in a source at a higher layer, and also executes the control processing for switching the image data being displayed in the display section 20 to the image data at a higher layer. More specifically, the control section 140 makes the information communicating section 130 output a signal indicating that the information currently being processed is terminated and the queuing state enabling source switching is effected to drive the processing unit's main frame 300 based on this signal. Further the control section 140 makes the display control section 143 terminate display of the main image data 700 belonging to a category corresponding to the lower-layer information currently being processed or display the name bar 720 for the main image data 700 with the grey background indicating that the main image data 700 has not been selected, and also makes the display control section 143 display the display image data 600 at a upper layer with a bright color indicating that the display image data 600 has been selected.

In this state, when a user performs an input operation by rotating the rotor 30 for switching a source to select other source, the control section 140 fetches an electric signal corresponding to rotation of the rotor 30 from the rotation detecting sensor of the operating section 110. Then the control section 140 recognizes a rotating direction of the rotor 30 based on the electric signal as switching request information for switching to other source in the layer, and provides controls for source switching.

Namely the control section 140 makes the image compression processing section 141 compress and generate the source image data 610 in a source corresponding to the display image data 600 having been displayed and the source image data 610 in a next source based on the order information which is play-list information stored in the storage section 120 to generate one piece of switching image data 650. Further the switching image data 650 is subjected to the tone processing by the tone processing section 142. Then the display control section 143 displays the switching image data 650 having been subjected to the tone processing on the display device 20.

Further the control section 140 makes the image compression processing section 141 compress the source image data 610 in the selected source and the image data 610 in a source following the next source according to the necessity and locate the two pieces of source image data 610 in both sides of the source image data 610 in the next source to generate the image data 610 into the display image data 600 for the next source. Further this display image data 600 is subjected to the tone processing by the tone processing section 142. Then the display control section 143 executes the processing for displaying the display image data 600 having been subjected to the tone processing after the switching image data 650 previously displayed is displayed.

Although the description above assumes a case where the image generation processing and tone processing are executed upon recognition of the switching request information and the generated switching image data 650 is displayed before the display image data 600 for the next source, the configuration is allowable in which, for instance, the display image data 600 and the switching image data 650 are previously generated and stored in the storage section 120 or in the main frame's storage section 360. Further the configuration is allowable in which, upon recognition of switching request information, based on an electric signal from the operating section 110 as well as the order information as play-list information, the corresponding image data 650 and the display image data 600 are successively read out and displayed according to the necessity.

The period of time for displaying the switching image data 650 is set to that in which the switching image data 650 can hardly be recognized, for instance, to 0.1 to 0.5 second. With this processing, the user feels that the screen display of the display image data 600 for the source displayed on the display section 20 is a substantially cylindrical column and is rotating in synchronism to rotation of the rotor 30 around the vertical axis of the input device 100 as the rotation axis.

The case where “@ab”, one site for musical data distribution service (EMD) is selected is described.

In this case, in response to an input operation for switching source information so that the lower-layer information at a lower-layer in the selected source of “@ab”, the processing corresponding to this input operation is executed in the input device 100. Namely, when the rotor 30 of the input device 100 is oscillated downward, an oscillation detecting sensor (not shown) of the operating section 110 outputs an electric signal in response to the oscillation of the rotor 30. The control section 140 fetches this electric signal, recognizes an oscillating direction of the rotor 30 based on this electric signal as switching request information indicating the user's request for switching from the layer to the lower-layer information at a lower-layer, and executes the switching operation. Namely the control section 140 provides the control for processing the lower-layer information for a source selected and decided by the processing unit's main frame 300, and the control for switching the image data currently being displayed on the display section 20 to the image data at a lower-layer than that of the current image data.

Specifically, the control section 140 makes the information communicating section 130 fetch program table information which is play-list information in the lower-layer information for the source “@ab” and output an electric signal indicating that the queuing state for the processing of lower-layer information is effected, and also makes the processing unit's main frame 300 operate based on this signal. Further the control section 140 makes the display control section 143 display the display image data 600 at a layer of the source selected and decided as described above with the grey background indicating that the display image data has not been selected and also display, for instance, the main image data 700 corresponding to the play-list information or program table information in the lower-layer information of the source or the main image data 700 corresponding to the lower-layer information at a first order in the play-list information or the program table information. When displaying the main image data 700, the display control section 143 displays the name bar 720 colored with a bright color indicating that the main image data 700 has been selected.

In this state, namely in the state where the lower-layer information of the source “@ab” has been selected, the control section 140 provides the control, by rotating the rotor 30, for switching from the program currently being processed by the processing unit's main frame 300 to the program to be processed next, and for switching from the main image data 700 of the program currently being displayed in the display section 20 to the main image data 700 of the program to be displayed next. Specifically, the control section 140 determines, based on an order of the program table information as well as on a rotating direction of the rotor 30, whether the program is one with the preceding order or with the following order, and makes the information communicating section 130 output a signal corresponding to the program to be processed next, and further fetches the information for the program from the processing unit's main frame 300.

Then the main frame control section 310 in the processing unit's main frame 300 recognizes the program to be processed next, in response to an electric signal outputted from the information communicating section 130 of the input device 100, based on the play-list information in the layer currently being processed. Then, to output the information to be processed such as the recognized program, the control section 140 provides controls for the information fetching section 320, output section 330, communicating section 340, driver 350, and main frame storage section 360 according to the necessity to output the required information from the output section 330.

In the input device 100, the main image data 700 for the program having been processed and the main image data 700 for the lower-layer information recognized based on the play-list information as that to be processed next are subjected to the processing and synthesis by the image compression processing section 141 as described above with reference to FIG. 8A to FIG. 8E to generate, for instance, three pieces of switching image data 750 each compressed at a different compression ratio. Further the switching image data 750 is subjected to the tone processing by the tone processing section 142. Then the display control section 143 successively displays the three pieces of switching image data 750 in the ascending order of the compression ratios to the main image data 700 for the lower-layer information having been processed, and then displays the main image data 700 for the next lower-layer information.

The description above assumes a case where the image generation processing and tone processing are performed upon recognition of switching request information and then the next main image data 700 is displayed with the generated switching image data 750 inserted therein, but the configuration is allowable in which the switching image data 750 is previously prepared and stored in the storage section 120 or in the main frame storage section 360. In this case, when the switching request information is recognized, the corresponding switching image data 750 is read out from the storage section 120 based on an electric signal from the operating section 110 and the play-list information to successively display the switching image data 750, and then the main image data 700 for the next lower-layer information is displayed.

The period of time for display the three pieces of switching image data 750 is set to that in which each of the switching image data can hardly be recognized visually, namely, for instance, to the range from 0.5 to about 1 second in all. With this processing, a user feels that the screen display of the main image data 700 for the lower-layer information displayed on the display unit 20 is like a substantially cylindrical column and rotates around the vertical axis of the input device 100 as the rotation axis.

In this state, when a user inputs data for selecting the program currently being displayed for receiving the distribution service, the control section 140 provides controls for carrying out the distribution service. Namely, in the state where the program is being displayed, the control section 140 recognizes an electric signal from the operating section 110 generated in response to downward oscillation of the rotor 30, and determines that a request for prespecified data input has been made (step S18).

When this request is recognized, the control section 140 connects the processing unit's main frame 300 to a server unit 430, fetches information for receiving the distribution service, and transfers the information to the input device 100. Then the control section 140 has a data input screen for receiving the distribution service displayed on the display unit 20 based on the information fetched from the server unit 430 (step S21).

The data input screen includes, for instance, a matrix to which a cursor can be moved to select one figure, and a text box for entry of data such as a code number. When a user rotates the rotor 30 on this data input screen to change a figure pointed by the cursor and then oscillate the rotor 30 downward to select the number, the selected figure is entered in the text box.

As described above, when data input into the text box is complete and the user oscillates the rotor 30 downward to indicate that the service distribution is to be carried out (step S22), and then the information corresponding to the input data is transmitted to the processing unit's main frame 300 (step S23). The processing unit's main frame 300 having received the information corresponding to the input data (step S24) makes the communicating section 340 transmit the information to the server unit 430 so that the information such as required musical data or image data is downloaded to the processing unit's main frame 300. Then the processing unit's main frame 300 outputs an electric signal indicating that the required information has been downloaded to the input device 100 (step S25). When the electric signal indicating that the downloading is complete from the processing unit's main frame 300 is received, the control section 140 has the image data displayed as the main image data 700.

Then, after a prespecified period o time has passed, the control section 140 again provides controls to display the main image data 700 for the program again.

(Effects of the Embodiments)

As described above, in this embodiment, the image data currently being displayed on the display device 20 and the image data to be displayed next are compressed by the image compression processing section 141 so that the two types of image data are displayed with smaller dimensions in respective directions as compared to those on a screen display on the display unit 20, and a plurality of compressed image data are combined, so that the plurality of pieces of image data adjoin to each other and are located side by side along the direction in which the compression is made, to generate one piece of switching image data 650, 750. Then, when the switching request information requesting switching of the image data currently being displayed is recognized, the display control section 143 displays the switching image data 650, 750 for a prespecified period of time on the display unit 20 and then display the next image data.

Because of the configuration, the state of switching to the next screen data can dynamically and visually be recognized, so that the adaptability of image data to be well appreciated can be improved. Especially, by providing a plurality of pieces of switching image data 750 displayed for a short period of time during the switching of image data, the image data can dynamically and visually be recognized more smoothly.

When a plurality of pieces of switching image data 750 are provided, the switching image data 750 is compressed at a compression ratio different from that for the image data to be displayed next, and the plurality of pieces of switching image data 750 are displayed in the descending order of the compression ratios, and then the image data to be displayed next is displayed, so that the image data can dynamically and visually be recognized with simple configuration smoothly.

Further the tone processing is executed by the tone processing section 142 to change thickness in brightness at least in a portion of the switching image data 650, 750, so that the screen display looks like a substantially cylindrical column and the display looks as if the cylindrical column rotates, whereby the adaptability of the image data to be well appreciated is further improved.

Especially, as also the display image data or the explanation bar 82 for a source containing a small volume of information to be displayed are subjected to the tone processing, the screen display looks like a cylindrical column, whereby the adaptability of the image data to be well appreciated is further improved. In this embodiment, such a trouble that contents of a display becomes not clear because the tone processing is not carried out to, for instance, the main domain data 799 containing a large volume of information to be displayed can be prevented, and contents of each display can easily and accurately be recognized. The configuration is also allowable in which the tone processing is carried out also to the main image data 700 to further improve visibility of the cylindrical column.

The tone processing is carried out in correspondence to positions in the image data at upper and lower-layers, so that the cylindrical screen display can visually be recognized better.

Further the direction in which the switching image data 650, 750 is compressed, the direction in which the plurality of pieces of the compressed image data are combined, and the direction in which the rotor 30 of the operating section 110 for inputting the switching request information for switching the image data is rotated are aligned, so that the image data is displayed as a substantially cylindrical column rotating in synchronism to rotation of the rotor 30, and therefore the adaptability of the image data to being well appreciated is further improved.

Further the display unit 20 is provided in the input device 20, so that the situation of data input can visually be checked, namely selection or decision of the information to be processed and input of specified data can visually be checked, so that data input for various types of processing can accurately be inputted to the processing unit's main frame even with simple configuration like the rotor 30, whereby the appearance and operability of the information display unit can be improved as compared to that having a plurality of buttons or the like based on the conventional technology.

Further, when one piece of data is displayed, as other data preceding and following the current data in terms of an order in the play-list information are displayed, the next information can easily be recognized. Further even if a number of the switching image data 650, 755 each inserted and placed between image data to be displayed is reduced, dynamic visual recognition is possible, so that workload in the image processing can be reduced. This configuration is especially effective when a volume of information to be displayed is small like in the cases of upper layer information in a source or a category.

Further, as data for processing various types of information can be set and inputted with the input device 100, a button or a volume for inputting various types of information in the processing unit's main frame 300 is not required to be provided, whereby configuration of the processing unit's main frame 300 can be simplified with the size reduced, and further the adaptability to being manufactured is improved with the production const reduced.

As the information processing system 200 comprises the input device 100 and the processing unit's main frame 300, the adaptability of processed information to being well appreciated is improved and excellent information processing can be performed.

By using the program for executing processing operations in the control section 140, for instance, in a personal computer, such a device as a mobile telephone terminal can be used as the input device 100, whereby smooth and excellent communication can be performed, which enables extension of this system for private use. Further by using a recording medium with the program recorded therein, program treatment is simplified, which also contributes to extension of this system for private use.

(Variants of the Embodiments)

It is to be noted that the present invention is not limited to the embodiments described above, and the following variants as those described below can be achieved within the scope of the present invention.

Namely configuration of the input device 100 is not limited to those as shown in FIG. 1 through FIG. 3, and the configuration is allowable in which various types of buttons are provided in place of the rotor 30 for inputting switching request information, or in which a mobile phone is used as an input device as described above.

Further the input device according to the present invention may be used as a remote controller used as an input device for various types of electric equipment for home use such as a ventilation system, an illumination system, a cleaner, and a camera so that compressed image data can be inserted when switching image data to be displayed.

The description above assumes a case where the tone processing is carried out to the switching image data 650, 750, but the tone processing is not always required. Likely the description above assumes a case where the tone processing is carried out also to the display image data 600, but the tone processing is not always required like in processing the main image data 700.

Further data produced by combining main image data preceding and following the current image data may be used as the main image data like the display image data 600. Further the tone processing may be carried out to the main image data. When a volume of contents to be displayed is large, preferably the compressed data is not combined like in the embodiments described above so that the user can easily recognize the displayed contents.

Further a number of layers is not limited to two like in “TV” or “TUNER” described above in which the lower-layer comprises programs and there is no layer under the lower-layer. For instance, the three or more-layered configuration like the “HDD” described hereinafter, in which a plurality of directories as a plurality of information are provided in the lower-layer and further each of the directory comprises a plurality of further lower information such as musical data, is allowable, and also the configuration is allowable in which, when image data corresponding to a program not including any further lower-layer information is switched, the corresponding image data is inserted for display between a plurality of pieces of image data successively displayed.

The term of “computing section” as used herein includes, for instance, one unit of personal computer, a system consisting of a plurality of computers combined in the network, and even a circuit substrate with chip (s) each as an IC or a CPU for a microcomputer or the like or a plurality of electric components incorporated therein.

Specific structures and procedures required for carrying out the present invention may be modified within the scope of the present invention.

What is claimed is:

1. An information display unit comprising:
a play-list information fetching section for fetching a play-list information concerning an order for display of a plurality of image data;
a switching request information fetching section for fetching a switching request information for requesting switching of image data to be displayed; and
a control section for controlling the display section to display image data to be displayed next according to said play-list information by fetching switching request information with this switching request information fetching section, wherein said control section comprises:
an image compression processing section for compressing the image data being currently displayed on the display section and the image data to be displayed next according to the play-list information to the state in which the image data is displayed on the screen display with smaller dimensions in respective directions compared to those of a normal screen display of the image data and also generating one piece of compressed image data by combining a plurality of pieces of said compressed image data so that those image data adjoin to each other along the direction in which the image data is compressed; and
a display control section for providing controls so that said compressed image data is displayed first on said display section and then the image data to be displayed next is displayed by fetching the switching request information with said switching request information fetching section.

2. An information display unit comprising:
a play-list information fetching section for fetching play-list information concerning a order for display of a plurality of image data;
a switching request information fetching section for fetching a switching request information for requesting switching of image data to be displayed; and
a control section for controlling the display section to display image data to be displayed next according to the play-list information by fetching switching request information with this switching request information fetching section, wherein said control section comprises:
an image compression processing section for compressing a series of image data displayed according to an order in the play-list information of the image data displayed to the state in which the image data is displayed on the screen with smaller dimensions in respective directions compared to those of a normal screen display of the image data and also generating one piece of display image data by combining a plurality of pieces of said compressed image data so that those image data adjoin to each other along the direction in which the image data is compressed; and
a display control section for displaying said display image data as the image data displayed.

3. The information display unit according to claim 2, wherein the image compression processing section executes the processing for compressing the image data being currently displayed on the display section and the image data to be displayed next according to said play-list information to the state in which the image data is displayed on the screen display with smaller dimensions in respective direction compared to those of a normal screen display of the image data and also generating one piece of compressed image data by combining a plurality of pieces of said compressed image data so that those image data adjoin to each other along the direction in which the image data is compressed, and
the display control section provides controls, by fetching the switching request information from the switching request fetching section, so that said compressed image data is displayed first on said display section and then the display image data assigned to be displayed next is displayed.

4. The information display unit according to claim 1, wherein the control section has a tone processing section for changing the thickness in brightness at least in a portion of the compressed image data, and
the display control section provides controls, by fetching the switching request information with the switching request fetching section, so that said compressed image data having been subjected to the tone processing by the tone processing section is displayed first on said display section and then the display image data is displayed as said image data to be displayed next.

5. The information display unit according to claim 2, wherein the control section has a tone processing section for changing the thickness in brightness at least in a portion of the compressed image data, and
the display control section provides controls, by fetching the switching request information with the switching request fetching section, so that said compressed image data having been subjected to the tone processing by the tone processing section is displayed first on said display section and then the display image data is displayed as said image data to be displayed next.

6. The information display unit according to claim 1, wherein the image compression processing section generates a plurality of pieces of compressed image data compressed at different compression ratios respectively, and
the display control section provides controls, by fetching the switching request information from the switching request information fetching section, so that said plurality of pieces of compressed image data are displayed first in the descending order of the image compression ratios, and then the image display data assigned to be displayed next is displayed.

7. The information display unit according to claim 2, wherein the image compression processing section generates a plurality of pieces of compressed image data compressed at different compression ratios respectively, and
the display control section provides controls, by fetching the switching request information from the switching request information fetching section, so that said plurality of pieces of compressed image data are displayed first in the descending order of the image compression ratios, and then the image display data assigned to be displayed next is displayed.

8. The information display unit according to claim 1, wherein information is correlated to image data to be displayed respectively,
said information contains a plurality of pieces of lower-layer information each with image data correlated to the lower-layer; and
the display control section also displays, when image data is displayed, the image data for the lower-layer information contained in the information correlated to the displayed image data.

9. The information display unit according to claim 2, wherein information is correlated to image data to be displayed respectively,
said information contains a plurality of pieces of lower-layer information each with image data correlated to the lower-layer; and
the display control section also displays, when image data is displayed, the image data for the lower-layer information contained in the information correlated to the displayed image data.

10. The information display unit according to claim 8, wherein the play-list information fetching section can fetch the lower-layer play-list information concerning an order of image data for a plurality of pieces of lower-layer information,
the switching request information fetching sections can fetch the lower-layer switching request information for requesting the switching of image data for the lower-layer information to be displayed,
the image compression processing section compresses the image data for the lower-layer information being currently displayed and the image data to be displayed next according to said lower-layer play-list information to the state in which the image data is displayed on the screen with smaller dimensions in respective directions compared to those of a normal screen display of the image data and also generating one piece of compressed lower-layer image data by combining a plurality of pieces of said compressed image data so that those image data adjoin to each other along the direction in which the image data is compressed; and
the display control section provides controls, by fetching the lower-layer switching request information with said switching request information fetching section, so that said lower-layer compressed image data is displayed first on said display section and then the image data for the lower-layer information to be displayed next is displayed.

11. The information display unit according to claim 9, wherein the play-list information fetching section can fetch the lower-layer play-list information concerning an order of image data for a plurality of pieces of lower-layer information,
the switching request information fetching sections can fetch the lower-layer switching request information for requesting the switching of image data for the lower-layer information to be displayed,
the image compression processing section compresses the image data for the lower-layer information being currently displayed and the image data to be displayed next according to said lower-layer play-list information to the state in which the image data is displayed on the screen with smaller dimensions in! respective directions compared to those of a normal screen display of the image data and also generating one piece of compressed lower-layer image data by combining a plurality of pieces of said compressed image data so that those image data adjoin to each other along the direction in which the image data is compressed; and
the display control section provides controls, by fetching the lower-layer switching request information with said switching request information fetching section, so that said lower-layer compressed image data is displayed first on said display section and then the image data for the lower-layer information to be displayed next is displayed.

12. The information display unit according to claim 8, wherein the play-list information fetching section can fetch the lower-layer play-list information concerning a order of image data for a plurality of pieces of lower-layer information,
the switching request information fetching sections can fetch the lower-layer switching request information for requesting the switching of image data for the lower-layer information to be displayed,
the image compression processing section compresses the image data for lower-layer information sequentially displayed in said lower-layer play-list information in the image data for lower-layer information being displayed to the state in which the image data is displayed on the screen with smaller dimensions in respective directions compared to those of a normal screen display of the image data and also generating one piece of compressed lower-layer display image data by combining a plurality of pieces of said compressed image data so that those image data adjoin to each other along the direction in which the image data is compressed, and
the display control section displays said lower-layer display image data as image data for lower-layer information to be displayed.

13. The information display unit according to claim 9, wherein the play-list information fetching section can fetch the lower-layer play-list information concerning a order of image data for a plurality of pieces of lower-layer information,
the switching request information fetching sections can fetch the lower-layer switching request information for requesting the switching of image data for the lower-layer information to be displayed,
the image compression processing section compresses the image data for lower-layer information sequentially displayed in said lower-layer play-list information in the image data for lower-layer information being displayed to the state in which the image data is displayed on the screen with smaller dimensions in respective directions compared to those of a normal screen display of the image data and also generating one piece of compressed lower-layer display image data by combining a plurality of pieces of said compressed image data so that those image data adjoin to each other along the direction in which the image data is compressed, and
the display control section displays said lower-layer display image data as image data for lower-layer information to be displayed.

14. The information display unit according to claim 12, wherein the image compression processing section compresses the image data for lower-layer information being displayed and image data to be displayed next according to the play-list information so that the image data is displayed as a screen display with smaller dimensions compared to those of a normal screen display of the image data and also generating one piece of compressed lower-layer display image data by combining a plurality of pieces of lower-layer compressed image data so that those image data adjoin to each other along the direction in which the image data is compressed, and
the control display section makes said switching request information section fetch the lower-layer switching request information, display said lower-layer compressed image data first and then lower-layer display image data of the image data for the lower layer information to be displayed next.

15. The information display unit according to claim 13, wherein the image compression processing section compresses the image data for lower-layer information being displayed and image data to be displayed next according to the play-list information so that the image data is displayed as a screen display with smaller dimensions compared to those of a normal screen display of the image data and also generating one piece of compressed lower-layer display image data by combining a plurality of pieces of lower-layer compressed image data so that those image data adjoin to each other along the direction in which the image data is compressed, and
the control display section makes said switching request information section fetch the lower-layer switching request information, display said lower-layer compressed image data first and then lower-layer display image data of the image data for the lower layer information to be displayed next.

16. The information display unit according to claim 10, wherein the tone processing section can execute the tone processing for generating changes in thickness at least in a portion of the lower-layer compressed image data; and
the display control section makes the switching request information fetching section fetch the lower-layer switching request information, display the lower-layer compressed image data having been subjected to the tone processing by the tone processing section first, and then display the image data to be displayed next.

17. The information display unit according to claim 11, wherein the tone processing section can execute the tone processing for generating changes in thickness at least in a portion of the lower-layer compressed image data; and
the display control section makes the switching request information fetching section fetch the lower-layer switching request information, display the lower-layer compressed image data having been subjected to the tone processing by the tone processing section first, and then display the image data to be displayed next.

18. The information display unit according to claim 10, wherein the image compression processing section generates a plurality of pieces of lower-layer compression image data each compressed at a different compression ratio; and
the display control section makes the switching request information fetching section fetch the lower-layer switching request information, and display said plurality of pieces of lower-layer compressed image data successively in the descending order of the compression ratios on the display section first, and then the image data to be displayed next.

19. The information display unit according to claim 11, wherein the image compression processing section generates a plurality of pieces of lower-layer compression image data each compressed at a different compression ratio; and
the display control section makes the switching request information fetching section fetch the lower-layer switching request information, and display said plurality of pieces of lower-layer compressed image data successively in the descending order of the compression ratios on the display section first, and then the image data to be displayed next.

20. The information display unit according to claim 16, wherein the portion where the tone processing section carries out a tone change on compressed image data is substantially the same as the portion where the tone processing section carries out a tone change on lower-layer compressed image data.

21. The information display unit according to claim 17, wherein the portion where the tone processing section carries out a tone change on compressed image data is substantially the same as the portion where the tone processing section carries out a tone change on lower-layer compressed image data.

22. An information display method comprising the steps of:
fetching play-list information concerning a display order of a plurality of pieces of image data;
compressing the image data being currently displayed on the display section and the image data to be displayed next according to said play-list to the state in which the image data is displayed on the screen with smaller dimensions in respective directions compared to those of a normal screen display of the image data;
generating one piece of compressed lower-layer display image data by combining a plurality of pieces of lower-layer compressed image data so that those image data adjoin to each other along the direction in which the image data is compressed; and
fetching the switching request information for requesting switching of image data being currently displayed to display said compressed image data first and then the image data to be displayed next.

23. An information display method comprising the steps of:
fetching play-list information concerning a display order of a plurality of pieces of image data;
compressing the image data displayed according to an order thereof in said play-list information to the state in which the image data is displayed on the screen with smaller dimensions in respective directions compared to those of a normal screen display of the image data;
generating one piece of compressed lower-layer display image data by combining a plurality of pieces of lower-layer compressed image data so that those image data adjoin to each other along the direction in which the image data is compressed; and
fetching the switching request information for requesting switching of image data to display the image data of said display image data.

24. An information display program for execution of the information display method according to claim 22.

25. An information display program for execution of the information display method according to claim 23.

26. A recording medium, according to claim 24, with the information display program recorded therein readable via arithmetic unit.

27. A recording medium, according to claim 25, with the information display program recorded therein readable via arithmetic unit.

28. An input device comprising:
the information display unit according to claim 1; and
an operating section for inputting data for the switching request information indicating that image data displayed by said information display unit in response to the input operation on the display section.

29. An input device comprising:
the information display unit according to claim 2; and
an operating section for inputting data for the switching request information indicating that image data displayed by said information display unit in response to the input operation on the display section.

30. The input device according to claim 28, wherein said operating section has a rotor; and
the image compression processing section of the information display unit combines the image data compressed along a rotating direction of the rotor so that the plurality of pieces of compressed image data adjoin to each other.

31. The input device according to claim 29, wherein said operating section has a rotor; and
the image compression processing section of the information display unit combines the image data compressed along a rotating direction of the rotor so that the plurality of pieces of compressed image data adjoin to each other.

32. An information processing unit comprising:
the information display unit according claim 1; and
an information processing section for processing information correlated to image data displayed by the information display unit on the display section.

33. An information processing unit comprising:
the information display unit according claim 2; and
an information processing section for processing information correlated to image data displayed by the information display unit on the display section.

34. An information processing unit comprising:
the input device according claim 28; and
an information processing section for processing information correlated to image data displayed by the information display unit on the display section of the input device.

35. An information processing unit comprising:
the input device according claim 29; and
an information processing section for processing information correlated to image data displayed by the information display unit on the display section of the input device.
